(19) United States
(12) Patent Application Publication
(10) Pub. No.: US 2006/0048803 A1
(43) Pub. Date: Mar. 9, 2006

(54) No contact spray apparatus cleaning device

(76) Inventors: Philip Jessup, Peterborough (CA); James Doyle, Peterborough (CA)

Correspondence Address: J. GORDON THOMSON, 1353 MOUNTAINSIDE CRESCENT, OTTAWA, ON, K1E 3G5, CA

(21) Appl. No.: 10/538,424

(22) PCT Filed: Feb. 21, 2003
(86) PCT No.: PCT/CA03/00239

§ 371 Date: Jun. 10, 2005

(51) Int. Cl. B08B 3/00

(52) U.S. Cl. 134/198; 134/95.2; 134/95.3

(57) ABSTRACT

The invention is an automatic no contact machine for cleaning and drying tips, air caps, retainers and cups on spray apparatus when changing liquid or when the apparatus will be idle, or to remove build up of paint on applicators that cause spits and drips on surfaces and electrostatic arcing to spray apparatus while containing and recovering cleaning effluents to an environmental standard.

### BACKGROUND OF THE INVENTION

1. Field of the Invention

The invention pertains generally to an industrial machine. More specifically, the invention relates to a no contract spray apparatus cleaning device for the robotic spray paint line industry, utilizing solvent recovery systems. The invention includes a unique no contact sealing system, one solvent line with a spray block head or plurality of spray heads and check valves and one air line with a velocity ring contained in a unique body and a second external air line connected to an evaporator drying system, connected to the body of the cleaning device which is connected to a solvent recovery system.

The current method of cleaning spray apparatus is largely to manually clean the spray tip. Some users insert and mechanically seal a spray gun tip into an opening in a cleaning tank that is connected to a solvent recovery system. When mechanically sealed in the solvent recovery system, to prevent air born effluent, the plumbing lines of the spray equipment are flushed with solvent or recharged, and the sealed tip of the spray apparatus is cleaned and dried using one solvent and one air supply line contained within the cleaning tank.

The invention possesses numerous benefits and advantages over known spray apparatus cleaning devices. In particular, the invention utilizes the principals of fluid dynamics to seal the spray apparatus tip in the system without physical contact. This no contact seal greatly reduces the cost of manufacturing the invention, and damage to the spray apparatus tip caused by conventional contact sealing.

The invention eliminates gun spits and drips related to air caps on automatic robotic paint guns. Moreover, the invention has no high speed moving parts, which reduces maintenance and the possibility of fire related to rotary friction or build up of static electricity. Because of its flexibility, effectiveness and simplicity in use, installation, and manufacture, the invention realizes a reduction in costs and in the costs of ongoing maintenance, while maintaining an environmental standard.

A practical example of the flexibility possessed by the invention resides in its ability to clean air caps as well as cap mounting rings. As well as cups on rotary applicators that have self-internal cleaning. Furthermore the invention is compatible with automatic colour changes, as well as mid colour run cap soaks. The invention further improves electrostatic transfer by cleaning spray apparatus external parts to prevent current tracking when using electrostatic painting techniques.

In addition to the foregoing attributes, the invention possesses numerous other financial and environmental benefits over conventional devices. The invention's external air dry system is a benefit by eliminating the use of air knifes that plug up while sweeping the face of the air cap to dry the paint gun and eliminate solvent drips that affect production. The advantage of a check valve in the spray head keeps the solvent line charged, so minimal solvent and time is used when cleaning. Standard cleaning time is 0.5-1 second, thereby speeding up cleaning and increasing productivity.

It can thus be seen that the present invention provides a novel machine, which successfully cleans and dries spraying apparatus.

### DESCRIPTION OF THE PREFERRED EMBODIMENT

With reference to the drawings and in particular, with reference to FIGS. 1-3, the no contact spray apparatus cleaning device comprises a body, indicated generally at 1, fabricated as an integral fabrication of an rigid material, preferably a metal. The body is defined by a front wall 9, a rear wall 10, a pair of side walls 11, a pair of solvent strippers 12, and a top wall 13. A no contact seal opening 2 is formed in the top wall.

Attached through the rear wall 10 and extending into the body is the air velocity ring supply line 5 and solvent spray head block supply line 7.

The mounting block 4 attached to the exterior of the rear wall of the body holds the evaporator assembly line 6 that delivers air to the sweep evaporator head 3.

With reference to the drawings and in particular, with reference to FIGS. 3-5 contained with in the body of the device are the velocity ring 15, velocity port 16, the spray head block 17, supply lines 19 and the spray nozzle 18.

With reference to the drawings FIG. 6, the spray head assembly comprises, the block, a ball 22, a spring 23, an o-ring 24, a nozzle 18, a retainer 25, fastener 26 and fitting 27.

The spray gun apparatus is programmed to be inserted into the no contact seal opening at which point the velocity ring is turned on to create the low pressure area. When the spray gun tip reaches a pre-determined depth, solvent is sprayed through the spray head assembly onto the spray gun tip while the tip is being moved up to a pre-determined dwell position, at which time the solvent spray head is shut off and the evaporator horn assembly is energized. The spray gun tip is then withdrawn from the no contact sealing area in a rotational motion which allows the evaporator horn assembly to dry the spray gun tip with compressed air shaped to be evacuated into the formed opening. At the end of the rotational motion the evaporator horn assembly is shut off and the spray gun tip returns to its original program.

The expelled solvent is channeled by the solvent strippers, from the body, to a solvent recovery system.

### SUMMARY OF DRAWINGS

In the drawings, which form a part of this specification,

FIG. 1 is a semi-diagrammatic view of the automatic spray apparatus cleaning device according to one embodiment of the invention showing the automatic spray apparatus cleaning device:

FIG. 2 is a front semi-diagrammatic view of the device;

FIG. 3 is a transverse cross-sectional view, taken generally on line 8-8, FIG. 1, with some parts deleted for clarity of illustration;

FIG. 4 is a semi-diagrammatic view of the velocity ring assembly viewed from the opening in the bottom of the device;

FIG. 5 is a semi-diagrammatic view of the spray block assembly viewed from the opening in the bottom of the device;

FIG. 6 is an exploded view of the spray block head assembly;

FIG. 7 is a semi-diagrammatic view of the evaporator assembly.

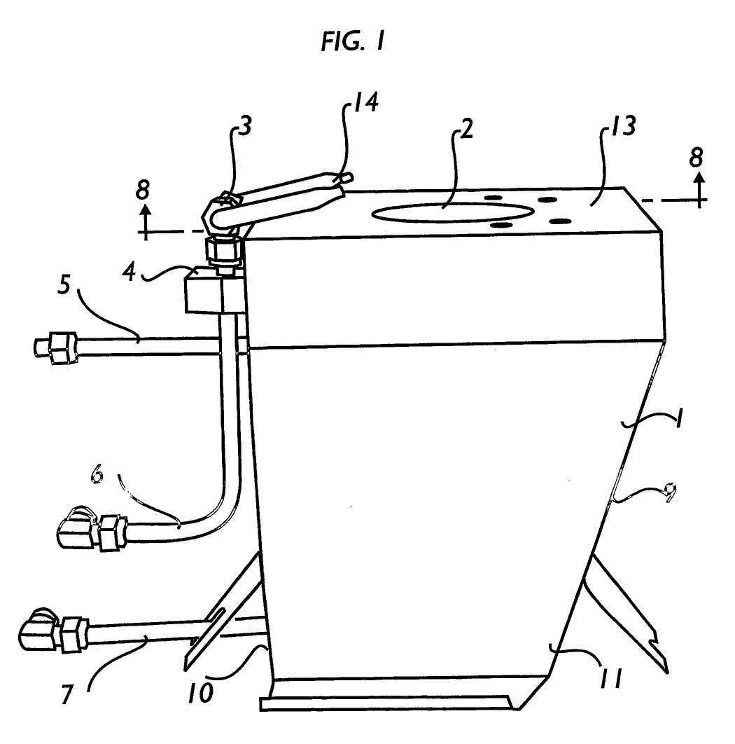

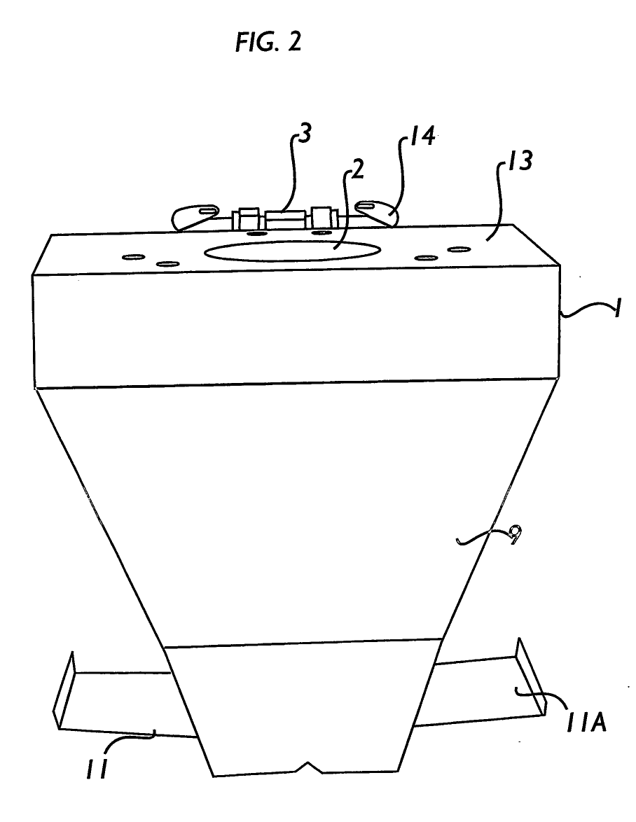

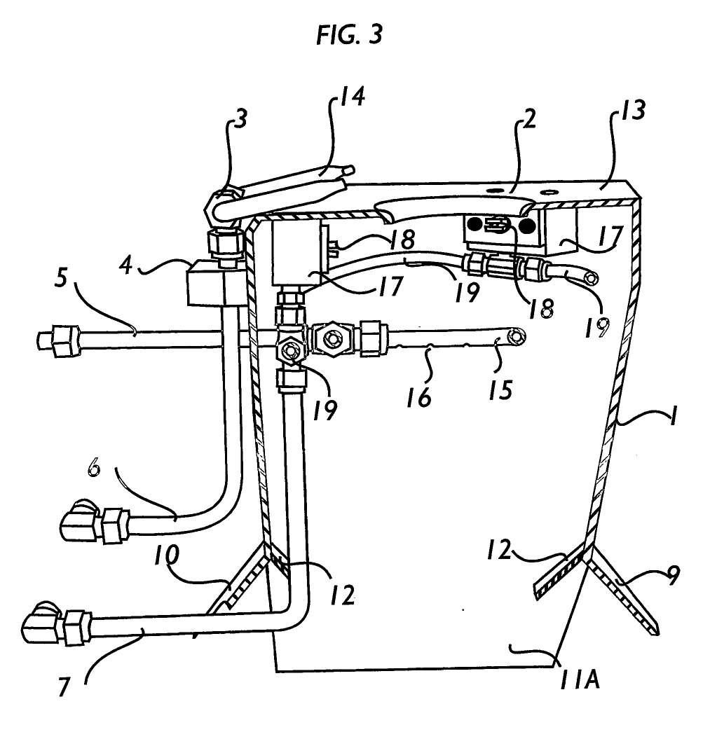

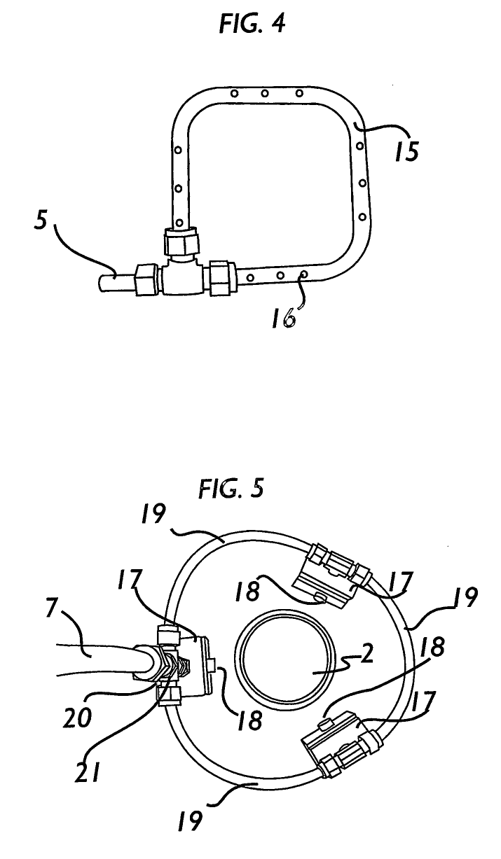

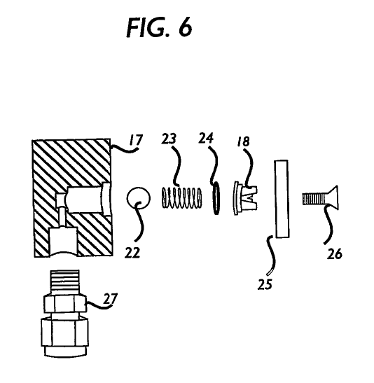

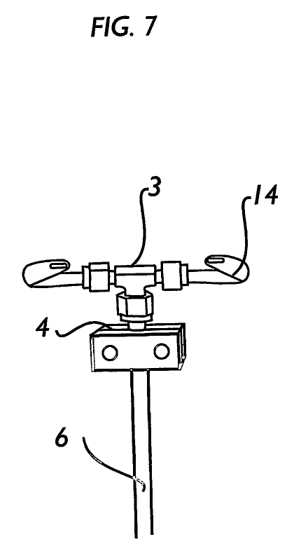

1. A device for cleaning and drying an object, comprising a top wall having portions defining at least one opening providing a means to achieve a low pressure area, a velocity ring, at least one spray head and at least one air sweep nozzle, with relational locations.

2. A device as claimed in claim 1, where the object to be cleaned is a spray gun apparatus.

3. A device as claimed in claim 1, with a container enclosing the low-pressure area.

4. A device as claimed in claim 1, wherein a means of generating air flow is provided.

5. A device as claimed in claim 4, wherein the means of air flow is a velocity ring connected to compressed air.

6. A device as claimed in claim 4, wherein a means of spraying solvent on the object to be cleaned is provided.

7. A device as claimed in claim 4, wherein the relational location of the velocity ring is below the formed opening.

8. A device as claimed in claim 1, wherein the means of spraying solvent on the object to be cleaned is a spray head or plurality of spray heads.

9. A device as claimed in claim 8, wherein a means of preventing solvent from leaking down is a ball check valve.

10. A device as claimed in claim 8, wherein the relational location of the velocity ring is below the spray head.

11. A device as claimed in claim 1, with a means for drying the cleaned object.

12. A device as claimed in claim 11, wherein the means of drying is passing air over the cleaned object.

13. A device as claimed in claim 11, wherein the means passing air over the cleaned object is an air sweep nozzle.

14. A device as claimed in claim 11, wherein the relational location of the sweep nozzle is above the opening formed in the top wall.

15. A cleaning device wherein the object to be cleaned is present into a formed opening wherein a low pressure area is created by the movement of air by means of a velocity ring, wherein solvent is sprayed on the object as it is retracted back through the opening, wherein the object is dried using compressed air shaped to be evacuated into the formed opening.
